(19) United States
(12) Patent Application Publication
(10) Pub. No.: US 2026/0004569 A1
(43) Pub. Date: Jan. 1, 2026

(54) SOUNDING OBJECT FOCUSED SEGMENTATION FOR AN AUDIO-VISUAL SCENE

(71) Applicant: International Business Machines Corporation, Armonk, NY (US)

(72) Inventors: Shi Yun Liang, Shanghai (CN); Yuan Yuan Ding, Shanghai (CN); Yong Sun, Shanghai (CN); Zhong Yuan Sun, Shanghai (CN); Jing Zhang, Shanghai (CN)

(21) Appl. No.: 18/755,841

(22) Filed: Jun. 27, 2024

(51) Int. Cl. G06V 10/80; G06V 20/40; H04R 5/04

(52) U.S. Cl. CPC G06V 10/806; G06V 20/46; H04R 5/04

(57) ABSTRACT

An image feature vector for a given video frame is generated from a given video and an audio feature vector for audio of the given video is generated. A textual description of the given video frame is generated and textual feature vectors are generated from the textual description. A first set of audio features of the audio feature vector and visual features of the image feature vector are fused to generate fused audio-visual features. A second set of audio features of the audio feature vector and the textual feature vectors are fused to generate fused audio-text features. A final mask is generated based on the fused audio-visual features and the fused audio-text features.

### BACKGROUND

The present invention relates generally to the electrical, electronic and computer arts and, more particularly, to machine learning, audio processing, and image processing.

### BRIEF SUMMARY

Principles of the invention provide systems and techniques for sounding object focused segmentation for an audio-visual scene. In one aspect, an exemplary method includes the operations of generating an image feature vector for a given video frame from a given video; generating an audio feature vector for audio of the given video; generating a textual description of the given video frame; generating textual feature vectors from the textual description; fusing a first set of audio features of the audio feature vector and visual features of the image feature vector to generate fused audio-visual features; fusing a second set of audio features of the audio feature vector and the textual feature vectors to generate fused audio-text features; and generating a final mask based on the fused audio-visual features and the fused audio-text features.

In one aspect, a computer program product comprises one or more tangible computer-readable storage media and program instructions stored on at least one of the one or more tangible computer-readable storage media, the program instructions executable by a processor, the program instructions comprising generating an image feature vector for a given video frame from a given video; generating an audio feature vector for audio of the given video; generating a textual description of the given video frame; generating textual feature vectors from the textual description; fusing a first set of audio features of the audio feature vector and visual features of the image feature vector to generate fused audio-visual features; fusing a second set of audio features of the audio feature vector and the textual feature vectors to generate fused audio-text features; and generating a final mask based on the fused audio-visual features and the fused audio-text features.

In one aspect, an apparatus comprises a memory and at least one processor, coupled to the memory, and operative to perform operations comprising generating an image feature vector for a given video frame from a given video; generating an audio feature vector for audio of the given video; generating a textual description of the given video frame; generating textual feature vectors from the textual description; fusing a first set of audio features of the audio feature vector and visual features of the image feature vector to generate fused audio-visual features; fusing a second set of audio features of the audio feature vector and the textual feature vectors to generate fused audio-text features; and generating a final mask based on the fused audio-visual features and the fused audio-text features.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an example system for identifying objects in a video, in accordance with an example embodiment;

FIG. 2 is a high-level block diagram of an example image-to-text process, in accordance with an example embodiment;

FIG. 3A is a high-level block diagram of an example visual feature extraction process, in accordance with an example embodiment;

FIG. 3B is a high-level block diagram of an example audio feature extraction process, in accordance with an example embodiment;

FIG. 4 is a high-level block diagram of an example audio-video fusion process, in accordance with an example embodiment;

FIG. 5 is a block diagram of an example system for generating a final mask 508, in accordance with an example embodiment; and

FIG. 6 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that, in general terms, an exemplary method, according to an aspect of the invention, includes the operations of generating an image feature vector 220 for a given video frame 212 from a given video; generating an audio feature vector 236 for audio 228 of the given video; generating a textual description 248 of the given video frame 212; generating textual feature vectors from the textual description; fusing a first set of audio features of the audio feature vector 236 and visual features of the image feature vector 220 to generate fused audio-visual features 440; fusing a second set of audio features of the audio feature vector 236 and the textual feature vectors 256 to generate fused audio-text features 504; and generating a final mask 508 based on the fused audio-visual features 440 and the fused audio-text features 504.

Technical advantages include:
more accurate and effective segmentation masks for identifying sound-emitting objects in videos where the masks are generated by incorporating audio, visual and textual information to assist in visual segmentation;
excellent segmentation results for objects associated with sound by using a fusion of complementary image and audio information (with a focus on extracting relevant attention points);
fusion of audio and visual features that guides the image segmentation process based on the similarity between the audio and visual features; and
fusion of audio and text features that guides the image segmentation process based on the similarity between the audio and text features, and assists in accurately identifying the primary source of a sound.

In one example embodiment, one or more objects in the given video frame 212 are identified based on the final mask 508.

The technical benefits include achieving the advantages as discussed above and enhancing capabilities of artificial intelligence to more accurately perform object or scenario recognition in an automated manner.

In one example embodiment, the generating the textual description 248 further comprises using a pre-trained image-to-text model, and wherein the textual feature vectors 256 are generated from the textual description by using word embedding techniques.

The technical benefits include achieving the advantages as discussed above and accessing the investigation- and computation-friendly format of vectors for facilitating automated and machine learning analysis.

In one example embodiment, the generating the audio feature vector 236 further comprises transforming the audio 228 into an audio spectrogram 308 using a short-time Fourier Transform and extracting at least one of the first set and the second set of audio features of the audio feature vector 236 from the audio spectrogram 308.

The technical benefits include achieving the advantages as discussed above and breaking down a complex waveform of an audio signal into individual components such as frequency components in order to facilitate automated analysis of the signals and the removal of unwanted noise or distortion.

In one example embodiment, the generating the image feature vector 220 from the given video frame 212 uses a pre-trained convolutional neural network model trained on an image dataset.

The technical benefits include achieving the advantages as discussed above and also tapping into parameter sharing benefits of convolution operations to extract and analyze visual features.

In one example embodiment, the final mask 508 is a pixel-level mask.

The technical benefits include achieving the advantages as discussed above and also enhancing accuracy of boundary delineation to facilitate improved object recognition via machine learning analysis.

In one example embodiment, a road accident is detected by identifying a visual object in the given video frame 212 in conjunction with an audio feature of the audio 228 of the given video based on the final mask 508.

Technical advantages include the ability to enhance artificial intelligence capability to automatically generate appropriate notifications, e.g., automatically generating a warning and a notification signal to appropriate parties or to a navigation system so that alternate routes are generated.

In one example embodiment, an improper operation of a machine is detected by identifying a visual object in the given video frame 212 in conjunction with an audio feature of the audio 228 of the given video based on the final mask 508.

Technical advantages include the ability to enhance artificial intelligence capability to automatically generate appropriate technological responses, e.g., automatically generating a warning or system automated shut off or automated presenting of equipment use educational materials.

In one aspect, a computer program product comprises one or more tangible computer-readable storage media and program instructions stored on at least one of the one or more tangible computer-readable storage media, the program instructions executable by a processor, the program instructions comprising generating an image feature vector 220 for a given video frame 212 from a given video; generating an audio feature vector 236 for audio 228 of the given video; generating a textual description 248 of the given video frame 212; generating textual feature vectors from the textual description; fusing a first set of audio features of the audio feature vector 236 and visual features of the image feature vector 220 to generate fused audio-visual features 440; fusing a second set of audio features of the audio feature vector 236 and the textual feature vectors 256 to generate fused audio-text features 504; and generating a final mask 508 based on the fused audio-visual features 440 and the fused audio-text features 504.

Technical advantages include more accurate and effective segmentation masks for identifying sound-emitting objects in videos where the masks are generated by incorporating audio, visual and textual information to assist in visual segmentation; excellent segmentation results for objects associated with sound by using a fusion of complementary image and audio information (with a focus on extracting relevant attention points); fusion of audio and visual features that guides the image segmentation process based on the similarity between the audio and visual features; and fusion of audio and text features that guides the image segmentation process based on the similarity between the audio and text features, and assists in accurately identifying the primary source of a sound.

Technical advantages include more accurate and effective segmentation masks for identifying sound-emitting objects in videos where the masks are generated by incorporating audio, visual and textual information to assist in visual segmentation; excellent segmentation results for objects associated with sound by using a fusion of complementary image and audio information (with a focus on extracting relevant attention points); fusion of audio and visual features that guides the image segmentation process based on the similarity between the audio and visual features; and fusion of audio and text features that guides the image segmentation process based on the similarity between the audio and text features, and assists in accurately identifying the primary source of a sound.

In one aspect, an apparatus comprises a memory and at least one processor, coupled to the memory, and operative to perform operations comprising generating an image feature vector 220 for a given video frame 212 from a given video; generating an audio feature vector 236 for audio 228 of the given video; generating a textual description 248 of the given video frame 212; generating textual feature vectors from the textual description; fusing a first set of audio features of the audio feature vector 236 and visual features of the image feature vector 220 to generate fused audio-visual features 440; fusing a second set of audio features of the audio feature vector 236 and the textual feature vectors 256 to generate fused audio-text features 504; and generating a final mask 508 based on the fused audio-visual features 440 and the fused audio-text features 504.

Technical advantages include more accurate and effective segmentation masks for identifying sound-emitting objects in videos where the masks are generated by incorporating audio, visual and textual information to assist in visual segmentation; excellent segmentation results for objects associated with sound by using a fusion of complementary image and audio information (with a focus on extracting relevant attention points); fusion of audio and visual features that guides the image segmentation process based on the similarity between the audio and visual features; and fusion of audio and text features that guides the image segmentation process based on the similarity between the audio and text features, and assists in accurately identifying the primary source of a sound.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
more accurate and effective segmentation masks for identifying sound-emitting objects in videos where the masks are generated by incorporating audio, visual and textual information to assist in visual segmentation;
excellent segmentation results for objects associated with sound by using a fusion of complementary image and audio information (with a focus on extracting relevant attention points);
fusion of audio and visual features that guides the image segmentation process based on the similarity between the audio and visual features; and
fusion of audio and text features that guides the image segmentation process based on the similarity between the audio and text features, and assists in accurately identifying the primary source of a sound.

With the development of artificial intelligence and deep learning, there has been an increasing amount of research focused on multimodal fusion, such as the fusion of audio and visual features in a video. Researchers have made attempts to fuse audio and visual information in various ways. For example, audio-visual matching aims to determine whether an audio signal and an image describe the same scene. Sound source localization visualizes the area where the sound source is located within video frames using a heat map. There have even been attempts to achieve pixel-level segmentation of sound-emitting objects. However, there are still significant challenges in sound source segmentation and the complete object segmentation required in video scenes. For example, conventional technology can only segment objects that are actively emitting sound, but not the fully related object (the object in the video in combination with the corresponding audio) which “tells the whole story.” Thus, in one or more embodiments, “Object” usually refers to the object or object in the video, while “fully related object” refers to the complete object associated with the audio. Some conventional solutions, for example, only output a bounding box or heat map to localize the sound source, but do not provide a pixel-level segmentation mask.

Consider a video frame of an individual playing a plano. Assume it is desired to segment both the plano producing the sound and the individual playing the plano. Existing solutions can only segment the plano producing the sound or the audience applauding in the surrounding area, but not both the plano producing the sound and the individual playing the plano.

Also consider a video frame of an individual operating machinery. Assume it is desired to monitor malfunctioning machines and identify unauthorized operations that may cause machine failures. Existing techniques can only segment the machines that are producing abnormal sounds, but cannot simultaneously segment the workers engaged in the unauthorized operations on the equipment.

Consider further a video frame of a player who is dribbling a ball in a video. Similar to the circumstances of the machinery operator, assume it is desired to segment both the player and the basketball. While prior art techniques may primarily segment the balls that are bouncing, the floor, or even the player's shoes, advantageously, one or more embodiments can accurately segment the desired objects: namely, the ball and the player.

Generally, techniques are disclosed for identifying objects in a video. Exemplary embodiments can successfully segment multiple objects, such as both the malfunctioning machine and the corresponding workers involved in the unauthorized activities, as discussed in the examples above. In one example embodiment, a method utilizes audio-visual fusion and audio-text fusion modules to provide more accurate localization for segmentation by leveraging sound, visual and textual information. Additionally, in one or more embodiments, a segmentation model is employed to achieve pixel-level object segmentation for video frames, ensuring precise segmentation results.

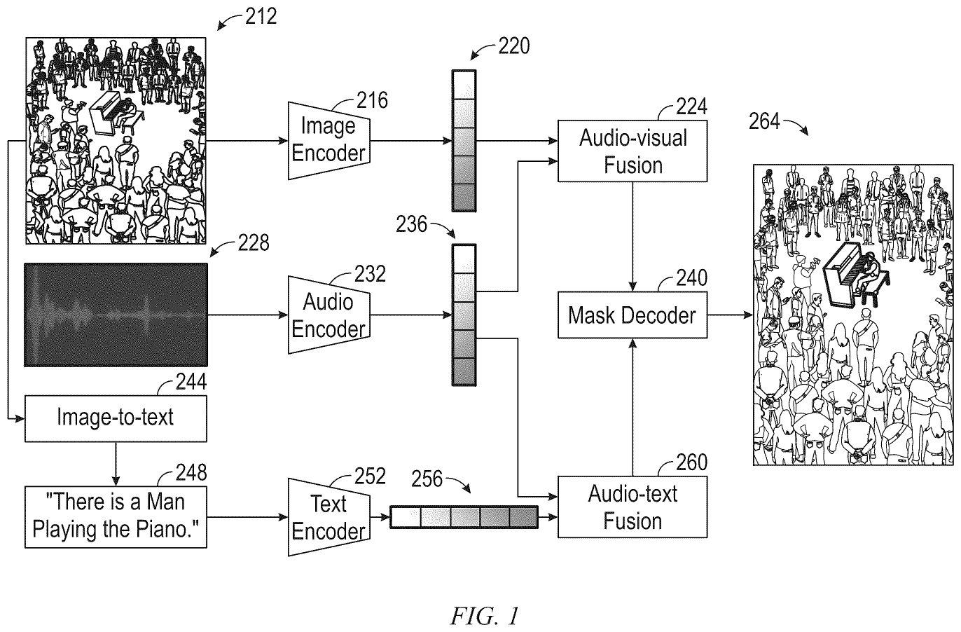

FIG. 1 is a block diagram of an example system for identifying objects in a video, in accordance with an example embodiment. The exemplary system includes the following four modules: an image-to-text module 244, an audio-visual fusion module 224, an audio-text fusion module 260, and a mask decoder 240.

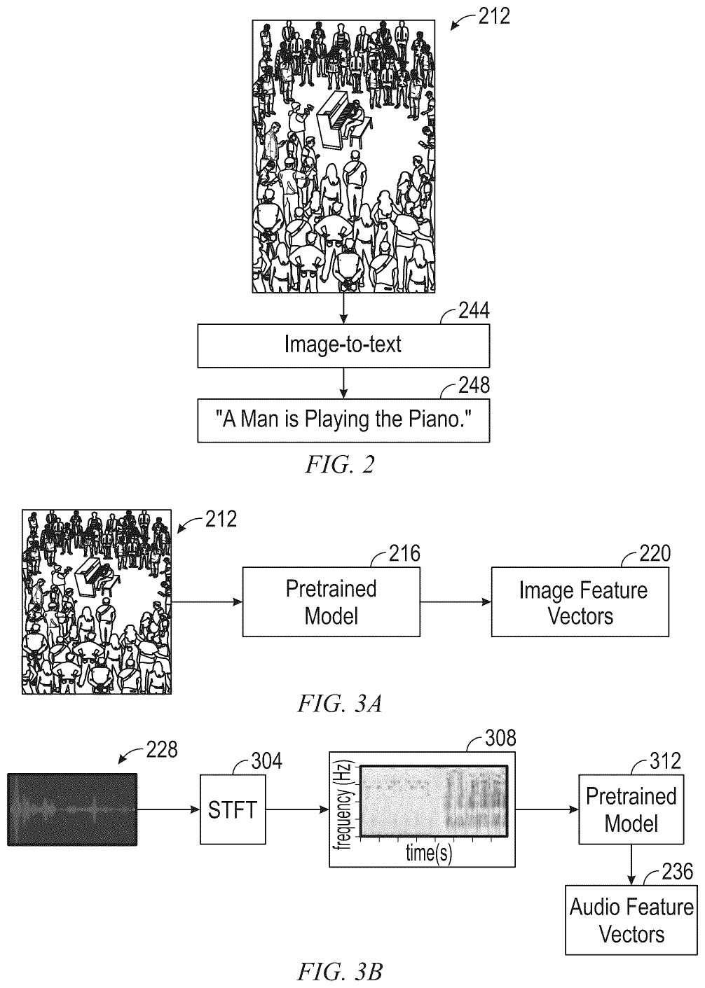

In one example embodiment, the image-to-text module 244 uses a pre-trained image-to-text machine learning model to generate textual descriptions 248 of video frames 212 of a given video. The textual information generated in the first step is transformed into feature vectors using word embedding techniques. In particular, these textual descriptions 248 are encoded by text encoder 252 to generate textual feature vectors 256. In one example embodiment, the image-to-text module 244 is implemented with a neural network and the text encoder 252 is implemented with a neural network. Additional details about the image-to-text module 244 and various possible embodiments of same are described below with respect to the description of FIG. 2. In general, the text encoder 252 can be implemented using a variety of neural network architectures. One approach is to use a transformer-based architecture, such as a Bidirectional Encoder Representations from Transformers (BERT) or a similar model, which has been pre-trained on a large corpus of text data and fine-tuned for specific tasks. Transformers are particularly effective for encoding textual data because they utilize self-attention mechanisms to capture contextual relationships between words in a sentence, allowing for a more nuanced understanding of the text.

The audio 228 of the given video is encoded by an audio encoder 232 to generate audio feature vectors 236. In one example embodiment, the audio 228 from the given video is transformed into an audio spectrogram using a short-time Fourier Transform. The STFT divides the audio signal into overlapping windows and applies the Fourier Transform to each window, producing a time-frequency representation of the audio signal. This representation highlights how the frequency content of the audio signal changes over time. Once the spectrogram is obtained, the audio encoder 232 processes this time-frequency representation to extract meaningful features from the audio spectrogram. An audio-text fusion module 260 fuses the features of the textual feature vectors 256 with the features of the audio feature vectors 236. The fusion of audio and text features guides the image segmentation process based on the similarity between the audio and text features and assists in accurately identifying the primary source of a sound.

In one example embodiment, the audio feature vectors 236 are extracted from the audio spectrogram utilizing a pre-trained deep neural network, such as a deep convolutional neural network (CNN) model. First, the audio spectrogram, which represents the frequency content of the audio signal over time, is generated from the raw audio data. Next, the pre-trained deep CNN model is employed to extract features from the spectrogram. This involves passing the spectrogram through the layers of the neural network, which has been trained on a large dataset to learn discriminative features relevant to audio analysis tasks. The features extracted by the deep CNN model capture high-level representations of the audio content, such as timbre, pitch, harmonic structure and the like. Finally, these features are aggregated or processed to produce a compact representation of the audio, typically in the form of a fixed-size feature vector.

An image encoder 216 processes each video frame 212 to generate image feature vectors 220. In one example embodiment, the visual features of the image feature vectors 220 are extracted using a pre-trained convolutional neural network model trained on an image dataset. The image dataset includes images with captions for those images. The captions acts as ground truth labels for the training to help the model learn to generate appropriate captions in response to receiving a new image. An audio-visual fusion module 224 fuses the visual features of the image feature vectors 220 and the audio features of the audio feature vectors 236. The fusion of audio and visual features guides the image segmentation process based on the similarity between the audio and image/visual features.

A mask decoder 240 module takes the fused audio-visual features from the audio-visual fusion module 224 and the audio-text fusion features from the audio-text fusion module 260 as input and generates pixel-level masks for the desired sound-emitting objects, as described more fully below in conjunction with FIG. 5. In this example shown in FIG. 1, the mask decoder 240 produces the first pixel-level mask 264.

### Image-to-Text Module

FIG. 2 is a high-level block diagram of an example image-to-text process, in accordance with an example embodiment. The image-to-text module 244 processes a video frame 212 to generate a textual description 248. There are a variety of networks/machine learning models available for image captioning and generating textual descriptions 248 from images 212. In one example embodiment, a querying transformer, which is currently known for its good performance, was used as the image-to-text model 244 for generating textual information for an image that is input. A querying transformer model is capable of doing zero-shot image-to-text generation. For most cases, a pre-trained querying transformer model can be used directly without any prompts.

In other embodiments, the image-to-text module 244 includes the combination of a convolutional neural network and a transformer architecture. The convolutional neural network extracts visual features from the images that are input. The transformer architecture includes an encoder and a decoder. The encoder receives the extracted visual features as inputs and generates new representations of the inputs. The decoder receives the new representations and produces the textual captions. The transformer is trained on pairs of visual features and textual captions (as sequences) to learn to generate captions based on the visual features.

By inputting a given video frame 212, the image-to-text model can generate a concise and descriptive caption that summarizes the main content of the video frame 212, similar to generating a short subtitle for the image 212. This description serves as the desired textual description 248. In some embodiments, a user fine-tunes a given image-to-text model using, for example, custom training data, to further improve its performance and adapt this model to specific tasks or domains. Providing accurate textual descriptions 248 directly for the current video frame 212 serves the purpose of filtering out irrelevant scenes and objects. By doing so, exemplary embodiments can focus more on the essential features of the main subject in the subsequent steps. This helps in reducing noise and distractions, enabling the model to better understand and analyze the key elements in the video frame 212.

### Feature Extractors

FIG. 3A is a high-level block diagram of an example visual feature extraction process, in accordance with an example embodiment. In one example embodiment, a pre-trained neural network 216, such as a convolutional neural network, is utilized to extract image (visual) features from the video frames 212 to generate the image feature vectors 220.

FIG. 3B is a high-level block diagram of an example audio feature extraction process, in accordance with an example embodiment. In one example embodiment, a short-time Fourier Transform 304 is employed to obtain an audio spectrogram 308 from the audio 228. A pre-trained model 312, such as an audio convolutional neural network model, is then used to extract the audio features of the audio feature vectors 236.

### Multi-Modal Fusion

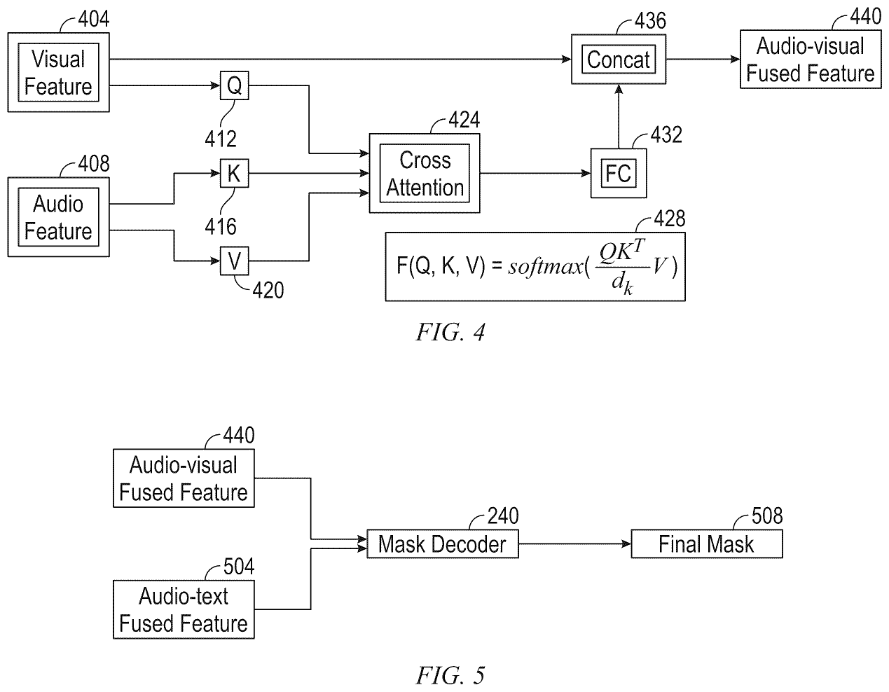

FIG. 4 is a high-level block diagram of an example audio-video fusion process, in accordance with an example embodiment. Thus, FIG. 4 illustrates details of an embodiment of the audio-visual fusion module 224 that was shown in FIG. 1. In one example embodiment, the audio 228 from the video is transformed into an audio spectrogram 308 using a short-time Fourier transform (as described above and shown in FIG. 3B). Audio feature vectors 236 are extracted from the audio spectrogram 308, and audio features 408 of the audio feature vectors 236 are fused with the visual features 404 of the image feature vectors 220 extracted by a pretrained convolutional neural network model 216 trained on an image dataset. The fusion of audio features 408 and the visual features 404 guides the image segmentation process based on the similarity between the audio and visual features.

In particular, the audio-visual fusion module 224 adjusts the extracted image feature vectors 220 and the audio feature vectors 236, respectively, to a unified dimension using fully connected layers. The fully connected layers (also known as dense layers) map the original feature vectors to a common feature space. This ensures that the features from different modalities are compatible for subsequent processing.

In at least some embodiments, the image and audio feature vectors from the image encoder 216 and from the audio encoder 232, respectively, are fed into a transformer encoder. A standard transformer encoder consists of multiple layers, each containing two main components: a multi-head self-attention mechanism and a feed-forward neural network. In example embodiments, instead of a self-attention mechanism, a cross-attention mechanism is used as part of the transformer. The attention mechanism in the transformer uses one modality (e.g., visual features) as the query and the other modality (e.g., audio features) as the key and value. This cross-attention technique allows the model to focus on relevant parts of the other modality when processing each element of the current modality. Thus, in example embodiments, a cross-attention architecture 424 from the transformer is employed to capture the correlation between the two modal features (the visual features 404 and the audio features 408). One modality's features 404, 408 serves as the query 412, while the other modality's features 404, 408 serve as the key 416 and value 420, resulting in a fused feature. As illustrated in the example of FIG. 4, the visual features 404 serve as the query 412, while the audio features 408 serve as the key 416 and value 420. The cross attention architecture uses an attention algorithm 428, and by mixing the sources of the query, key, and value in this attention algorithm 428 achieves the cross-attention and feature fusion. The result and the output of the audio-visual fusion module 224 are the audio-visual fused features 440. It is noted that both the visual features (extracted by the pre-trained model) and the audio features (derived from the spectrogram) might have different dimensions (number of elements). The fully connected (FC) layer 432 takes these features from the separate paths (image and audio) and adjusts them to a unified dimension. This adjustment ensures they can be compared and processed together in subsequent steps. The adjusted features from the different modalities, image and audio, are then combined by concatenator 436 to preserve features from different sources without further modification and allow the next layer to learn how to best utilize them together.

The audio-text fusion module 260 that was shown in FIG. 1 generally operates in the same manner as described above for the audio-visual fusion module 224, albeit using features of the textual feature vectors 256 instead of the visual features 404 of the image feature vector 220. Specifically, in at least some embodiments the audio-text fusion module 260 also implements a cross-attention mechanism and fully connected layers with some or all of the textual feature vectors 256 and with some or all of the audio feature vectors 236 to produce an audio-text fused feature 504 that is subsequently input into the mask decoder 240.

### Mask Decoder

FIG. 5 is a block diagram of an example system for generating a final mask 508, in accordance with an example embodiment. In one example embodiment, the mask decoder module 240 was implemented with a mask decoder that had been trained to generate masks based on receiving the inputs of (1) embeddings from an image and (2) features that were output by a prompt encoder. The mask decoder 240 takes the audio-visual fused features 440 and audio-text fused features 504 as input and generates pixel-level masks 508 for the desired sound-emitting objects. In the disclosed system, the audio-visual fused features 440 generated by the audio-visual fusion module 224 and the audio-text fused features 504 generated by the audio-text fusion module 260 are used as the inputs to the mask decoder 240. By passing these inputs through the transformer decoder block and the mask prediction head of the mask decoder 240, an output mask, such as the final mask 508, is obtained. A mask such as the final mask 508 is a segmentation product in which an image is partitioned into multiple segments, each segment being a depicted object or a region. In some instances, color changes are used within the produced mask to better delineate between one or more depicted objects in an image and other objects or background regions in an image. Specifically, such color changes occur around the peripheral border of an object or region identified within the image. For a pixel-level mask, the mask decoder 240 produces a label for each pixel within the image—the label indicating to what portion the particular pixel belongs, e.g., whether a pixel belongs to a depicted object, region, background, etc.

In example embodiments, the mask that is produced is then input into other downstream processing modules such as, but not limited to, machine learning models, e.g., classification models, or other portions of machine learning models that have been trained for a specific task to produce some classification output, image processing modules, feature extraction modules, computer vision algorithms, rule-based anomaly detection modules, statistical anomaly detection modules, threshold analysis modules, etc. In some embodiments, the masks are used in scenarios such as monitoring malfunctioning machines and identifying unauthorized operations. For example, masks produced as described in the present embodiments can thereafter be used to:
1) facilitate segmentation of machines and workers: the mask can concurrently segment malfunctioning machines and workers engaged in unauthorized operations using computer vision algorithms (e.g., deep learning for image recognition or segmentation, computer vision edge detection, computer vision Hough transformation, etc.) with the produced mask being input into the computer vision algorithm(s);
2) facilitate enhanced anomaly detection: in post-segmentation, the mask enhances anomaly detection by being used to identify abnormal activities around machinery (e.g., the mask produced as described herein is thereafter input into an anomaly detection module such as clustering algorithms, neural networks, rule-based systems, statistical analysis systems, etc.);
3) facilitate feature extraction for analysis: facilitates improved extracting of specific features from segmented areas, and aiding in the detection of machine malfunctions or unauthorized behaviors (e.g., the mask produced as described herein is thereafter input into a feature extraction portion of a convolutional neural network, a feature extraction portion of other image processing techniques, etc.); and
4) integration with monitoring systems: extracted information integrates seamlessly with monitoring systems that generate alerts and/or insights, enabling real-time analysis and proactive decision-making (e.g., the mask produced as described herein is input into a monitoring system that includes a machine learning model with feature extraction, a monitoring system based on predefined rules, a monitoring system based on threshold value evaluations, etc.).

In one example embodiment, video with audio of a road is input into the system to detect a road condition. For example, real-time images of the surrounding environment of a car are captured and the surrounding sounds are collected. When the car is driving normally on the road and an abnormal sound is heard, the model can use the collected images, sounds, and textual information (converted from images) to determine that a traffic accident occurred nearby and to identify the people and vehicles involved in the accident.

In one example embodiment, video with audio of factory equipment is input into the system to inspect the factory production. For example, in a factory equipped with cameras with microphones that capture real-time images and sounds within the factory, the captured multi-modal information is used to track the production. For example, when a worker improperly operates a machine and the machine, as a result, emits abnormal sounds, the model uses the captured images and sounds to accurately locate the anomalous machine and even identify the worker who is improperly operating the machine.

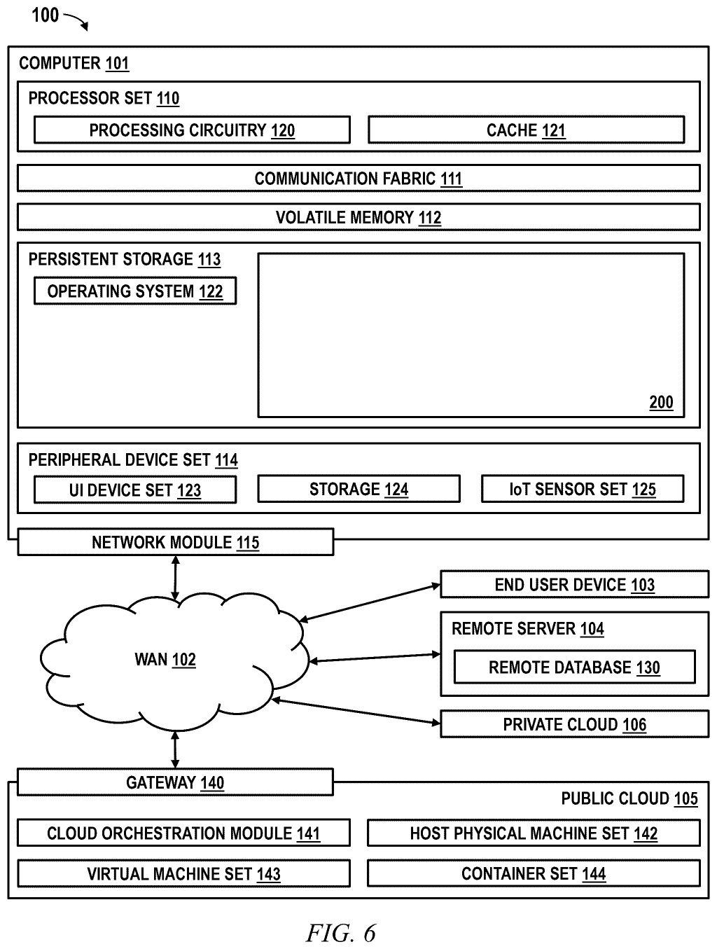

Generally, as will be discussed further below in connection with FIG. 6, aspects of the invention can be implemented using a software module 200 that can interface with sensors, machines, vehicles, and the like over a WAN 102 or other connection; the end user device 103 in FIG. 6 represents a variety of sensors, machines, vehicles, and the like.

Refer now to FIG. 6.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as audio-video-textual processor 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating an image feature vector for a given video frame from a given video;
generating an audio feature vector for audio of the given video;
generating a textual description of the given video frame;
generating textual feature vectors from the textual description;
fusing a first set of audio features of the audio feature vector and visual features of the image feature vector to generate fused audio-visual features;
fusing a second set of audio features of the audio feature vector and the textual feature vectors to generate fused audio-text features; and
generating a final mask based on the fused audio-visual features and the fused audio-text features.

2. The method of claim 1, further comprising identifying one or more objects in the given video frame based on the final mask.

3. The method of claim 1, wherein the generating the textual description further comprises using a pre-trained image-to-text model, and wherein the textual feature vectors are generated from the textual description by using word embedding techniques.

4. The method of claim 1, wherein the generating the audio feature vector comprises transforming the audio into an audio spectrogram using a short-time Fourier Transform and extracting at least one of the first set and the second set of audio features of the audio feature vector from the audio spectrogram.

5. The method of claim 1, wherein the generating the image feature vector from the given video frame uses a pre-trained convolutional neural network model trained on an image dataset.

6. The method of claim 1, wherein the final mask is a pixel-level mask.

7. The method of claim 1, further comprising detecting a road accident by identifying a visual object in the given video frame in conjunction with an audio feature of the audio of the given video based on the final mask.

8. The method of claim 1, further comprising detecting an improper operation of a machine by identifying a visual object in the given video frame in conjunction with an audio feature of the audio of the given video based on the final mask.

9. A computer program product, comprising:
one or more tangible computer-readable storage media and program instructions stored on at least one of the one or more tangible computer-readable storage media, the program instructions executable by a processor, the program instructions comprising:
generating an image feature vector for a given video frame from a given video;
generating an audio feature vector for audio of the given video;
generating a textual description of the given video frame;
generating textual feature vectors from the textual description;
fusing a first set of audio features of the audio feature vector and visual features of the image feature vector to generate fused audio-visual features;
fusing a second set of audio features of the audio feature vector and the textual feature vectors to generate fused audio-text features; and
generating a final mask based on the fused audio-visual features and the fused audio-text features.

10. The computer program product of claim 9, the program instructions further comprising identifying one or more objects in the given video frame based on the final mask.

11. The computer program product of claim 9, wherein the generating the textual description further comprises using a pre-trained image-to-text model, and wherein the textual feature vectors are generated from the textual description by using word embedding techniques.

12. The computer program product of claim 9, wherein the generating the audio feature vector further comprises transforming the audio into an audio spectrogram using a short-time Fourier Transform and extracting at least one of the first set and the second set of audio features of the audio feature vector from the audio spectrogram.

13. A system comprising:
a memory; and
at least one processor, coupled to said memory, and operative to perform operations comprising:
generating an image feature vector for a given video frame from a given video;
generating an audio feature vector for audio of the given video;
generating a textual description of the given video frame;
generating textual feature vectors from the textual description;
fusing a first set of audio features of the audio feature vector and visual features of the image feature vector to generate fused audio-visual features;
fusing a second set of audio features of the audio feature vector and the textual feature vectors to generate fused audio-text features; and
generating a final mask based on the fused audio-visual features and the fused audio-text features.

14. The system of claim 13, the operations further comprising identifying one or more objects in the given video frame based on the final mask.

15. The system of claim 13, wherein the generating the textual description further comprises using a pre-trained image-to-text model, and the textual feature vectors are generated from the textual description by using word embedding techniques.

16. The system of claim 13, wherein the generating the audio feature vector further comprises transforming the audio into an audio spectrogram using a short-time Fourier Transform and extracting at least one of the first set and the second set of audio features of the audio feature vector from the audio spectrogram.

17. The system of claim 13, wherein the generating the image feature vector from the given video frame uses a pre-trained convolutional neural network model trained on an image dataset.

18. The system of claim 13, wherein the final mask is a pixel-level mask.

19. The system of claim 13, the operations further comprising detecting a road accident by identifying a visual object in the given video frame in conjunction with an audio feature of the audio of the given video based on the final mask.

20. The system of claim 13, the operations further comprising detecting an improper operation of a machine by identifying a visual object in the given video frame in conjunction with an audio feature of the audio of the given video based on the final mask.
